(19) United States
(12) Patent Application Publication
(10) Pub. No.: US 2010/0229019 A1
(43) Pub. Date: Sep. 9, 2010

(54) Method of Controlling Spread-Spectrum Clock Generation

(76) Inventors: Chung-Ming Huang, Tainan (TW); Kuo-Chan Huang, Tainan (TW)

Correspondence Address: STOUT, UXA, BUYAN & MULLINS LLP, 4 VENTURE, SUITE 300, IRVINE, CA, 92618, US

(21) Appl. No.: 12/397,247

(22) Filed: Mar. 3, 2009

(51) Int. Cl. G06F 1/08; G06F 1/04; G06F 3/00

(52) U.S. Cl. 713/600; 710/52; 713/500

(57) ABSTRACT

A method of controlling spread-spectrum clock generation is disclosed. A first-in first-out (FIFO) buffer is first monitored. When the FIFO buffer is determined to be abnormal, an associated spread-spectrum clock generator (SSCG) is turned off or its spread range is decreased.

### BACKGROUND OF THE INVENTION

1. Field of the Invention

The present invention generally relates to spread-spectrum clocks (SSCs) and first-in first-out (FIFO) buffers, and more particularly to a method of controlling spread-spectrum clock generation.

2. Description of the Prior Art

Spread spectrum is a technique used to spread electromagnetic energy in the frequency domain. The spread-spectrum technique has been used in communication systems, in which the spread-spectrum signal is transmitted with a bandwidth larger than that of an original signal. In a digital system, the spread-spectrum technique is commonly used to reduce the spectral density of electromagnetic interference (EMI) within the digital system. Specifically, a spread-spectrum clock generator (SSCG) is primarily utilized in a digital system, which comprises particularly a portable or handheld system (such as a mobile phone) with image processing related integrated circuits (ICs), such as graphic ICs, video processors or timing controllers. Due to the difference between the original clock and the spread-spectrum generated clock, the SSCG is usually accompanied by an appropriate first-in first-out (FIFO) buffer to prevent data loss by temporarily storing a sufficient amount of data to maintain the data stream, such that no data overflow or under run will occur. For example, if the FIFO buffer receives less read clocks than write clocks, the FIFO buffer will overflow. Specifically, the data writing index of the FIFO buffer responds to, for example, a liquid crystal display (LCD) clock signal, and the data reading index of the FIFO buffer responds to the spread-spectrum clock (SSC). As a result, the LCD clock signal can be dispersed or its spectrum can be spread, and accordingly the EMI can be effectively reduced. The SSCG/FIFO is disclosed, for example, in U.S. Pat. No. 6,580,432, or in U.S. Pat. No. 7,429,963, the entire contents of which are hereby incorporated by reference.

The size of the FIFO buffer is a design issue that should be determined, among others, according to the percentage of the signal spreading and the modulation rate. A small FIFO buffer will likely and frequently lead to data overflow. While a large FIFO buffer can overcome the overflow problem, it nevertheless wastes chip area and unnecessarily consumes power. A compromise should be reached to determine an appropriate FIFO buffer size.

The issue of the FIFO buffer size becomes more complicated when two or more stages have their respective SSCGs. In such systems, a former stage with an SSCG will usually affect the design of the FIFO buffer size in the latter stage. Unfortunately, the issue has not been adequately discussed in connection with conventional systems such as those mentioned above, and no feasible solution has been proposed.

For the reason that conventional electronic systems, particularly video systems, could not effectively solve the FIFO overflow problem by optimizing the FIFO buffer size, a need has arisen to propose a method of spread-spectrum clock generation for preventing data overflow caused by a preceding SSCG.

### SUMMARY OF THE INVENTION

In view of the foregoing, it is an object of the present invention to provide a method of spread-spectrum clock generation that is capable of adaptively controlling the spread-spectrum clock generator (SSCG) of a current circuit stage in order to prevent it from being adversely affected by the SSCG of a preceding circuit stage.

According to an embodiment of the present invention, the margin of a first-in first-out (FIFO) buffer is monitored, and an associated SSCG is turned off when the margin is either less than zero or greater than the size of the FIFO buffer. According to another embodiment of the present invention, the margin of the FIFO buffer is monitored, and the spread range percentage of the SSCG is decreased when the margin is either less than zero or greater than the size of the FIFO buffer, with the embodiment otherwise maintaining the spread range percentage.

### BRIEF DESCRIPTION OF THE DRAWINGS

FIG. 1 shows a block diagram of a system including a spread-spectrum clock generator (SSCG) and a first-in first-out (FIFO) buffer;

FIG. 2A exemplifies a frequency of a first clock CLK1 with respect to time;

FIG. 2B exemplifies the frequency of a second clock CLK2 with respect to time;

FIG. 3 shows a schematic diagram of the data flow control in the FIFO buffer of FIG. 1;

FIG. 4A exemplifies a normal FIFO operation;

FIG. 4B exemplifies an abnormal FIFO operation;

FIG. 5A illustrates a flow diagram of the SSCG control according to a first embodiment of the present invention;

FIG. 5B exemplifies an upper bound and a lower bound for the FIFO margin; and

FIG. 6 illustrates a flow diagram of the SSCG control according to a second embodiment of the present invention.

### DETAILED DESCRIPTION OF THE INVENTION

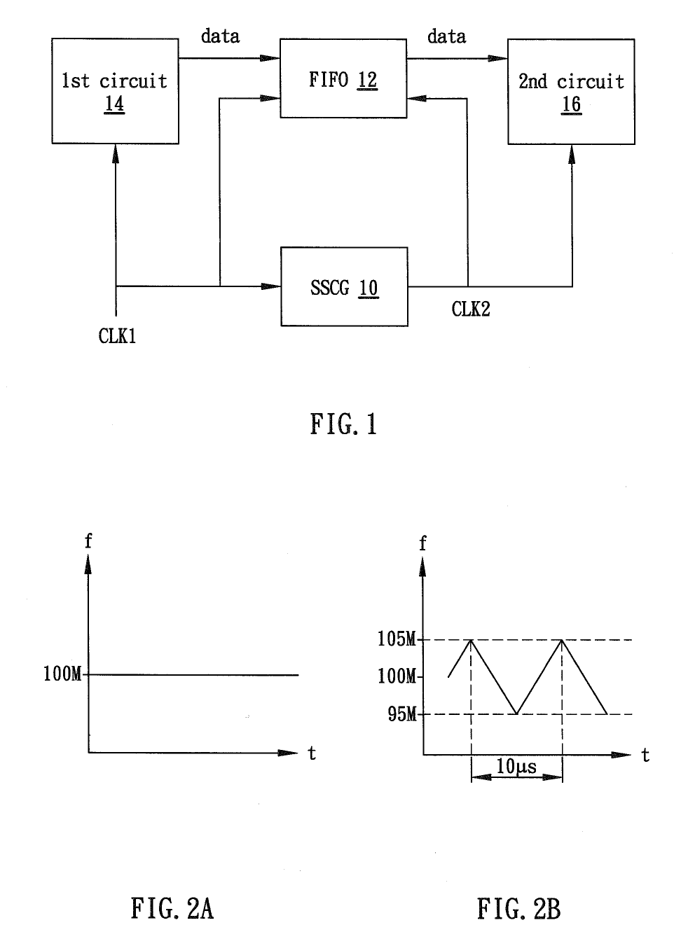

FIG. 1 shows the block diagram of a system including a spread-spectrum clock generator (SSCG) 10 and a first-in first-out (FIFO) buffer 12. Data provided by a first circuit 14 is written into the FIFO buffer 12 in accordance with an original first/input clock CLK1, and the data is read out of the FIFO buffer 12 (and then forwarded to a second circuit 16) in accordance with a second/output clock CLK2, which is the spread-spectrum clock (SSC) generated by the SSCG 10. FIG. 2A exemplifies a frequency of the first clock CLK1 with respect to time, and FIG. 2B exemplifies the frequency of the second clock CLK2 (i.e., SSC) with respect to time. It is observed that the first clock CLK1 has a constant frequency (e.g., 100 MHz), while the second clock CLK2 has the frequency fluctuating between 105M and 95MHz (i.e., 100M±5%). In this exemplary case, the spread range percentage of the spread-spectrum clock generation is 10%. It is also observed that the second clock CLK2 has the frequency oscillating with a periodic interval of 10μ second or 10⁻⁵ second. In this case, the modulation rate of the spread-spectrum clock generation is 100000(=1/10⁻⁵)/sec or 100 KHz.

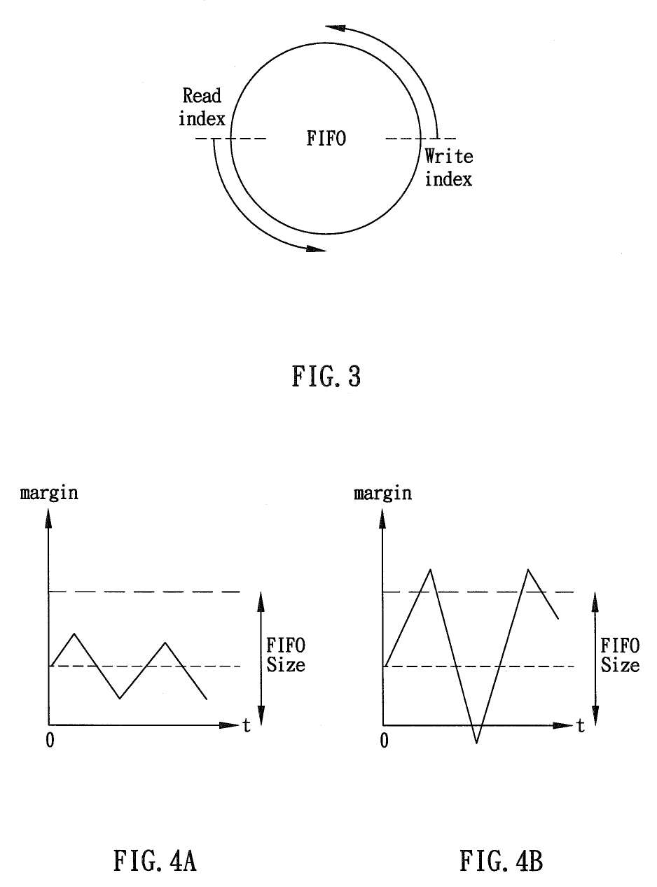

FIG. 3 shows a schematic diagram of the data flow control in the FIFO buffer 12 of FIG. 1. A write index (which is under control of the first clock CLK1 in FIG. 1) is used to denote the position of the latest written data (from the first circuit 14), and a read index (which is under control of the second clock CLK2 in FIG. 1) is used to denote the position of the latest read out data (to the second circuit 16). As shown in FIG. 3, the write index moves one step counterclockwise whenever a datum is written into the FIFO buffer 12, and the read index moves one step counterclockwise when a datum is read out of the FIFO buffer 12. A margin is defined as the difference between the write index and the read index (i.e., margin=write index−read index). In a normal operation of the FIFO buffer 12, the value of the margin should lie between the zero and the FIFO size (or depth). FIG. 4A exemplifies a normal FIFO operation, in which the margin is between the zero and the FIFO size. On the other hand, an abnormal situation (i.e., data overflow or under run) happens whenever the margin is either less than zero (i.e., margin<0) or greater than the FIFO size (i.e., margin>FIFO size). FIG. 4B exemplifies an abnormal FIFO operation, in which the margin is less than zero sometimes or is greater than the FIFO size sometimes. As described earlier, a current circuit stage normally operated under the internal spread-spectrum clock generation (SSCG) will probably be affected by a preceding circuit stage also equipped with an SSCG. In a worst-case situation, the current circuit stage will go into an abnormal operation as mentioned and depicted in FIG. 4B. Accordingly, a scheme should be devised to resolve this problem.

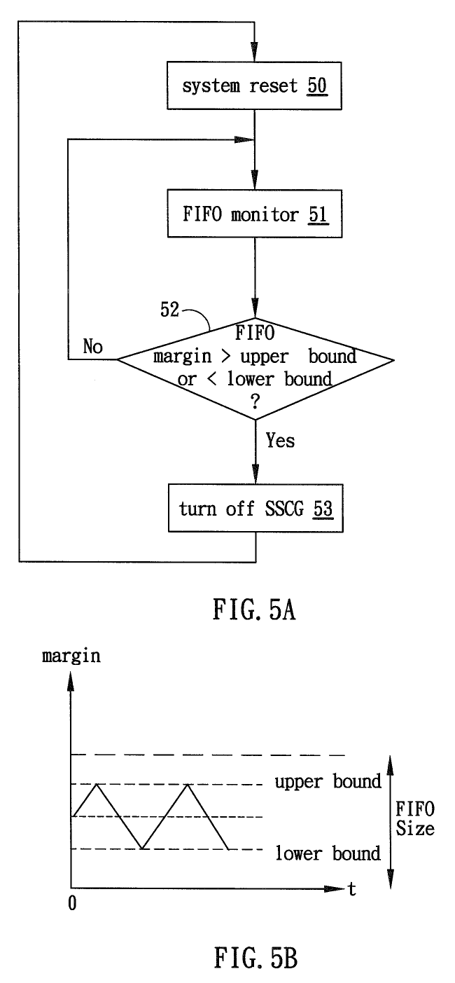

FIG. 5A illustrates a flow diagram of the SSCG control according to a first embodiment of the present invention. First, in step 51, the FIFO buffer 12 (FIG. 1) is monitored to continuously or intermittently collect the margin values. Subsequently, in step 52, when the collected margin is determined to exceed a predetermined upper bound or be lower than a predetermined lower bound (as shown in FIG. 5B), the SSCG 10 (FIG. 1) of the current circuit stage is turned off (step 53); otherwise, the FIFO monitoring of step 51 is continued. The upper bound may be set at, for example, but not limited to 80% of the FIFO size, and the lower bound may be set at, for example, but not limited to 20% of the FIFO size. Step 53, in the embodiment, is preferably performed during the vertical blanking interval for the purpose of not affecting video display. The turned-off SSCG 10 may be recovered when the next system reset occurs (step 50). In another embodiment, the turned-off SSCG 10 may be recovered during the next vertical blanking interval.

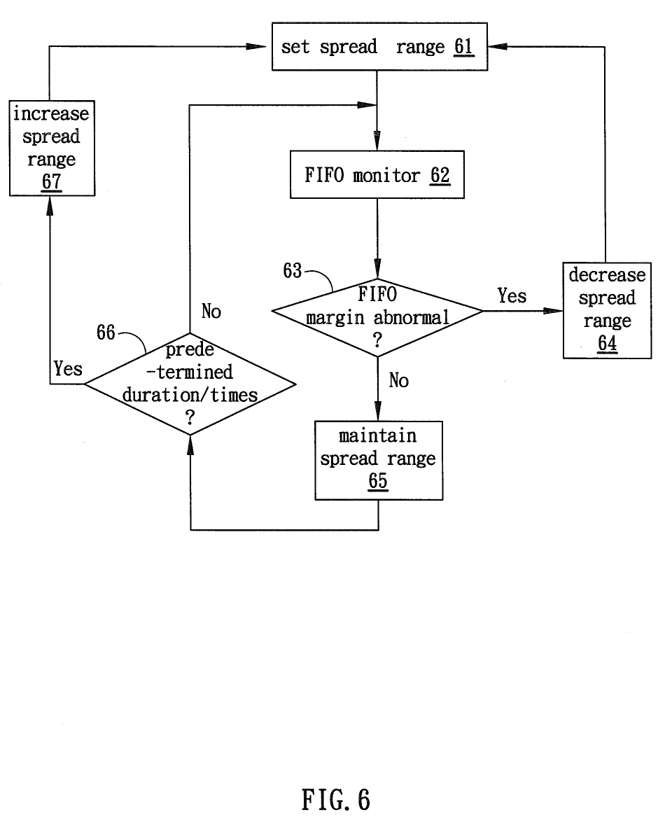

FIG. 6 illustrates a flow diagram of the SSCG control according to a second embodiment of the present invention. While the spread range percentage of the SSCG 10 (FIG. 1) has been adjusted in this embodiment, it is appreciated that other SSCG-related parameters, such as the modulation rate, may be adjusted also or instead. In the embodiment, in step 61, the spread range percentage of the SSCG 10 is first set at a predetermined value (for example, 10%). Subsequently, in step 62, the FIFO buffer 12 (FIG. 1) is monitored to continuously or intermittently collect the margin values. When the collected margin is determined (in step 63) to be abnormal, e.g., exceeding a predetermined upper bound or being lower than a predetermined lower bound (as shown in FIG. 5B), the spread range percentage of the SSCG 10 (FIG. 1) of the current circuit stage is regulated to be decreased (for example, 1% decreased) (in step 64), and is then used to set the SSCG 10 (in step 61). Otherwise, the spread range percentage is maintained or kept (step 65). In the embodiment, the SSCG is set to a decreased spread range percentage (in step 61) preferably during the vertical blanking interval for the purpose of not affecting video display. It is noted that, in step 64, the spread range percentage is decreased provided that an allowable lower limit or zero has not been reached.

Moreover, in the embodiment, if the spread range percentage has been maintained for a predetermined duration or for a predetermined number of times (step 66), the spread range percentage of the SSCG 10 (FIG. 1) of the current circuit stage is increased (for example, 1% increased) (in step 67), and is then used to set the SSCG 10 (in step 61); otherwise, continuation of the FIFO monitoring (step 62) occurs. It is noted that, in step 67, the spread range percentage is increased provided that an allowable upper limit has not been reached.

According to the embodiment, the SSCG 10 of the current circuit stage can be adaptively changed or adjusted such that the SSCG 10 of the current circuit stage will not be affected by the SSCG of a preceding circuit stage while the SSCG 10 and the FIFO buffer 12 can be utilized to greater extent.

Although specific embodiments have been illustrated and described, it will be appreciated by those skilled in the art that various modifications may be made without departing from the scope of the present invention, which is intended to be limited solely by the appended claims.

What is claimed is:

1. A method of controlling spread-spectrum clock generation, comprising:
monitoring a first-in first-out (FIFO) buffer; and
regulating an associated spread-spectrum clock generator (SSCG) whenever the FIFO buffer is determined to be abnormal.

2. The method of claim 1, wherein a margin of the FIFO buffer is monitored and is then used to determine the abnormality of the FIFO buffer.

3. The method of claim 2, wherein the margin of the FIFO buffer is a difference between a write index that is under control of an input clock of the SSCG and a read index that is under control of an output clock of the SSCG.

4. The method of claim 3, wherein the FIFO buffer is determined to be abnormal when the margin is either less than zero or greater than a size of the FIFO buffer.

5. The method of claim 1, wherein the SSCG is turned off when the FIFO buffer is determined to be abnormal.

6. The method of claim 5, wherein the SSCG is turned off during a vertical blanking interval.

7. The method of claim 5, wherein the SSCG is turned on again when a system reset occurs or during a vertical blanking interval.

8. The method of claim 1, wherein an SSCG-related parameter is adjusted when the FIFO buffer is determined to be abnormal.

9. The method of claim 8, wherein the SSCG-related parameter is a spread range percentage of the SSCG.

10. The method of claim 9, wherein the spread range percentage is decreased when the FIFO buffer is determined to be abnormal.

11. The method of claim 10, further comprising increasing the spread range percentage if the spread range percentage has been maintained for a predetermined duration or for a predetermined number of times.

12. The method of claim 8, wherein the SSCG-related parameter is a modulation rate of the SSCG.

13. A method of controlling spread-spectrum clock generation, comprising:
monitoring a margin of a first-in first-out (FIFO) buffer; and
turning off an associated spread-spectrum clock generator (SSCG) when the margin is either less than zero or greater than a size of the FIFO buffer;
wherein the margin of the FIFO buffer is a difference between a write index that is under control of an input clock of the SSCG and a read index that is under control of an output clock of the SSCG.

14. The method of claim 13, wherein the SSCG is turned off during a vertical blanking interval.

15. The method of claim 13, wherein the SSCG is turned on again when a system reset occurs or during a vertical blanking interval.

16. A method of controlling spread-spectrum clock generation, comprising:
monitoring a margin of a first-in first-out (FIFO) buffer; and
decreasing a spread range percentage of an associated spread-spectrum clock generator (SSCG) when the margin is either less than zero or greater than a size of the FIFO buffer, and otherwise maintaining the spread range percentage;
wherein the margin of the FIFO buffer is a difference between a write index that is under control of an input clock of the SSCG and a read index that is under control of an output clock of the SSCG.

17. The method of claim 16, further comprising increasing the spread range percentage if the spread range percentage has been maintained for a predetermined duration or for a predetermined number of times.
